(19) United States
(12) Patent Application Publication
(10) Pub. No.: US 2014/0280453 A1
(43) Pub. Date: Sep. 18, 2014

(54) Message Distribution

(71) Applicant: SOUTHERN CALIFORNIA PERMANENTE MEDICAL GROUP, Pasadena, CA (US)

(72) Inventors: John E. Mattison, San Diego, CA (US); Gregory S. Stearns, San Diego, CA (US); Allie Simon, San Diego, CA (US)

(73) Assignee: SOUTHERN CALIFORNIA PERMANENTE MEDICAL GROUP, Pasadena, CA (US)

(21) Appl. No.: 13/844,466

(22) Filed: Mar. 15, 2013

(51) Int. Cl. H04L 12/18

(52) U.S. Cl. CPC H04L 12/1854
USPC 709/202

(57) ABSTRACT

A system for distributing electronic messages includes: (a) a central server that is connected to a wide-area network and that stores substantive message content information and corresponding delivery information; and (b) a group of forwarding servers, each: being connected to the wide-area network and having an associated set of recipients. The central server is configured, based on the delivery information, to automatically transmit message information, which includes substantive message content information, across the wide-area network to at least a subset of the forwarding servers, with the substantive message content information being identical for all such forwarding servers. Each of such forwarding servers is configured, upon receipt of the message information, to automatically generate and then transmit to individual recipients within its associated set a message that includes the substantive message content information.

### FIELD OF THE INVENTION

The present invention pertains to systems, methods, techniques and apparatuses for distributing electronic messages, e.g., to a large number of people, but which, in the preferred embodiments, automates the algorithmic coordination of five elements: 1) the specific message content, 2) the specific media (plural) and sequence of media (plural) utilized, 3) the timing and sequence of messages, 4) the recipient, and 5) the sender.

### BACKGROUND

A variety of different electronic messaging systems currently exist. Examples include e-mail, texting, Twitter, Google+, Facebook and other social-network services, as well as various forms of personal avatars and brokered dialogues between sender avatar and receiving avatar as digital representatives of the sender and receiver respectively. However, the present inventor has discovered that such existing electronic messaging systems: (1) often end up being used for transmission of messages that are not wanted by the ultimate recipients and/or (2) are inadequate at helping people to create and send all of the messages that they would like (or that would be beneficial for them or for the ultimate recipients).

### SUMMARY OF THE INVENTION

One explicit purpose of the present invention is to automate the process of WHO notifies WHOM with WHICH specific message using a variety of social media tools. A simple illustration is that an automatically generated message about a new service or open appointment could be sent to all qualified individuals from their identified primary care physician. This would help the recipient understand that their personal physician has effectively consented to this personalized message, to distinguish it from the ‘spam’ that otherwise might arrive through the same media from the parent organization or executive of that organization. One point of novelty reflects the automation of the algorithmic method of personalizing the pentad of 1) the message, 2) the medium, 3) the timing, 4) the sender, and 5) the recipient. However, references throughout this disclosure to such a “pentad” and similar references to five parameters are merely exemplary and should not be understood as limiting. While previous products and services have automated various combinations of these five, it is the inclusion of all five parameters in the algorithmic automation that is novel.

Thus, the present invention provides, among other things, a system in which a central server manages message delivery and content information and uses it to generate message information that is transmits it to a number of different forwarding servers (or sender identities). These forwarding servers (or sending identities), in turn, then use the received message information to generate and transmit messages to individual end recipients. Such a multiple-stage, algorithmically automated, message-delivery system, can provide significant benefits. For example, by centralizing message-information generation, such a system can ensure that appropriate messages are sent out to appropriate people, using the optimal medium, timing, and from the sender most closely trusted by that individual (with their appropriate method of consent to this automation). At the same time, use of multiple different forwarding servers (or sub-service on the primary server), each of which typically being associated with a person or entity that has a fairly close relationship with the ultimate recipient, can, e.g.: enhance personalization of the messages that are sent, strengthen the relationship between the sending person/entity and the ultimate recipient, and increase the likelihood that the ultimate recipient will actually read and appropriately respond to the message.

One particular embodiment of the invention is directed to a system for distributing electronic messages that includes: (a) a central server that is connected to a wide-area network and that stores substantive message content information and corresponding delivery information; and (b) a group of forwarding servers (or subservices, the term ‘servers’ referring herein to logical services, whether or not they are physically distinct), each: being connected to the wide-area network and having an associated set of recipients, with automation of algorithmically and personalized delivery media. The central server is configured, based on the delivery information, to automatically transmit message information, which includes substantive message content information, across the wide-area network to at least a subset of the forwarding servers (or subservices), with the substantive message content information being identical for all such forwarding servers, except with respect to any addended information pertinent to the ultimate sending individual or agent. Each of such forwarding servers is configured, upon receipt of the message information, to automatically generate and then transmit to individual recipients within its associated set a message that includes the substantive message content information. Throughout this disclosure, the term “forwarding servers” is intended to include logical services (e.g., on a primary server) and other sending identities.

Also provided is a system for distributing electronic messages that customizes the distribution and content of multimedia messages using various communication media. There preferably are five parameters that guide the customization of the message campaign. Those five parameters are the sender, the recipient, the message, the communication media (plural), and the timing, sequence and repetition of the messaging. Further, the system allows for local modification of the messaging as it traverses each node in the communication network. The system includes: (a) a central server that is connected to a wide-area network and that stores substantive message content information and corresponding delivery information; and (b) a group of forwarding servers (or logical subservices), each: being connected to the wide-area network and having an associated set of recipients, and (c) a library of rules (algorithms) that help construct every aspect of the messaging campaign along all five parameters noted above. The central server is configured, based on the delivery information, to automatically transmit message information, which includes substantive message content information, across the wide-area network to at least a subset of the forwarding servers, with the substantive message content information being identical for all such forwarding servers. Each of such forwarding servers is configured, upon receipt of the message information, to automatically generate (with both automated and manual modification options) and then transmit to individual recipients within its associated set a message that includes the substantive message content information.

The foregoing summary is intended merely to provide a brief description of certain aspects of the invention. A more complete understanding of the invention can be obtained by referring to the claims and the following detailed description of the preferred embodiments in connection with the accompanying figures.

### BRIEF DESCRIPTION OF THE DRAWINGS

In the following disclosure, the invention is described with reference to the attached drawings. However, it should be understood that the drawings merely depict certain representative and/or exemplary embodiments and features of the present invention and are not intended to limit the scope of the invention in any manner. For example, the representation of distinct physical servers could equally be logical subunits of a single server, each of which represents a transmission node along an algorithmically and personalized pathway based upon the sender, the message, the recipient, the medium, and the timing. The following is a brief description of each of the attached drawings.

FIG. 1 is a block diagram illustrating the general arrangement of a system according to a first set of representative embodiments of the present invention.

FIG. 2 is a block diagram of a system for distributing electronic messages according to a first representative embodiment of the present invention.

FIG. 3 illustrates an exemplary message-delivery rule according to a representative embodiment of the present invention.

FIG. 4 is a block diagram of a system for distributing electronic messages according to a second representative embodiment of the present invention.

FIG. 5 is a block diagram of a system for distributing electronic messages according to a third representative embodiment of the present invention.

FIG. 6 is a flow diagram illustrating a process for delivering messages in accordance with the present invention.

FIG. 7 is a block diagram illustrating the general arrangement of a system according to a second set of representative embodiments of the present invention.

### DESCRIPTION OF THE PREFERRED EMBODIMENT(S)

The general arrangement of a system 5 according to a first set of representative embodiments of the present invention is illustrated in FIG. 1. As shown, system 5 includes a central server 10, maintained by one or more administrators 12, and a plurality of forwarding servers 15A-C (sometimes collectively referred to simply as forwarding servers 15 or individually referred to as a forwarding server 15). Each of the forwarding servers 15A-C is associated with, or under the control of, a particular person or entity which functions as its corresponding controlling entity 17A-C, respectively (sometimes collectively referred to as controlling entities 17 or individually referred to as a controlling entity 17). Each of the controlling entities 17A-C also has an associated set of recipients 20A-C, respectively (sometimes collectively referred to as recipients 20 or individually referred to as a recipient 20), and each recipient 20 has at least one networked device 25 available to him/her/it for receiving communications from the corresponding forwarding server 15.

As noted in greater detail below, the central server 10 can include just a single server device or can include multiple server devices (potentially even networked, geographically dispersed devices), e.g., having different functionalities (such as storage or network communications) but collectively working together as a single logical unit. Similar considerations apply to the forwarding servers 15. In some cases, a particular forwarding server 15 will be controlled by an entity 17 that is a small and/or mostly local business or other type of organization, in which case a single server device often will suffice (in some cases, just an ordinary desktop, laptop or even less powerful computing device configured to function as a server). In other cases, a forwarding server 15 will be controlled by a large (potentially national or even international) company or other type of organization, in which case multiple networked server devices might be desirable. Also, any given controlling entity 17 may elect to outsource some or all of its forwarding-server functionality 15 to another entity (e.g., to have it hosted in the “cloud”).

The recipients 20 typically are individual people, but at least some of them instead could be businesses or other types of organizations or entities, e.g., where there exists a business-to-business relationship between a controlling entity 17 and the corresponding recipient 20. The networked recipient devices 25 often will be ordinary consumer devices, such as a wireless (e.g., cellular-based) telephone, a tablet, a laptop computer or a desktop computer. However, e.g., for large organizational recipients 20, the corresponding recipient devices 25 can themselves be servers or other types of powerful computing systems or devices.

In any event, all of the various devices within system 5 (e.g., including central server 10, forwarding servers 15 and recipient devices 25) typically will communicate with each other via at least one wide-area network, such as the Internet, one or more cellular-based wireless networks, and/or a public switched telephone network (PSTN, sometimes referred to as a landline telephone network). More specifically, the communications 27 between central server 10 and the individual forwarding servers 15 often will rely solely on the Internet, while the communications 28 between the forwarding servers 15 and the individual recipient devices 25 typically will use various combinations of the foregoing wide-area networks and/or other communication networks. These topological assumptions are illustrative and exemplary but are not intended to be either restrictive or declarative.

Communications 28 (i.e., the messages sent from the forwarding servers 15 to their corresponding recipients 20) often will rely upon established communication protocols, such as e-mail, texting, Twitter, Google+, Facebook, avatar networks, or other social-network-service protocols, so as to be easily receivable by all or almost all of the potential recipients 20 without the installation of any special-purpose applications. Still further, for potential recipients 20 who are not “online”, or at least who are not online very often, the messages 28 can be transmitted as automated telephone messages (sometimes referred to as robocalls) or in any other way, using any available network or communication methodology. The unique attributes of how an individual interacts with each communication medium, both as they declare their preferences explicitly and we observe their behavior explicitly, preferably are exploited in how the pentad of components is customized to maximize the desired impact of a messaging campaign on a specific individual. In the preferred embodiments, the forwarding servers 15 support a variety of different consumer-oriented messaging protocols (such as any of those listed in the beginning of this paragraph) and have access to a variety of different communication networks, and the individual recipients 20 have the ability to choose (e.g., by clicking options presented on a provided user interface or through any other way of communicating with the corresponding controlling entity 17) one or more desired messaging services (e.g., by providing a corresponding electronic address, such as an e-mail address, Twitter address, telephone number, etc.) to be used for the communications 28 contemplated herein.

In certain embodiments, the communications 27 also can use any of the foregoing standard consumer-oriented messaging protocols. However, in the preferred embodiments, a proprietary protocol is used for communications 27, e.g., in order to provide greater flexibility and/or efficiency, as discussed in greater detail below. Still further, communications 27 can employ an existing communication protocol and then layer a proprietary protocol on top of it to achieve the desired flexibility and efficiency. In any event, the forwarding servers 15 preferably execute a special-purpose application (e.g., set of computer-executable process steps) to construct and send the recipient communications (or messages) 28 based on the received central-server communications 27, as discussed in greater detail below.

The following discussion often refers to a particular exemplary use of the system 5 in which the controlling entities 17 are individual physicians or medical offices and the recipients (or potential recipients) 20 are their patients. However, it should be understood that a system 5 according to the present invention can be used for a wide variety of purposes, such as: in business and/or commerce (e.g., for communicating with customers or potential customers), for the benefit of the public (e.g., for distributing notifications during times of emergency), and/or for facilitating communications to, and/or organization of, people and/or entities in a wide variety of other contexts (e.g., for mobilizing and effectively using staff and volunteers in a political campaign). More generally, message delivery according to the present invention can be advantageously used for any conceivable purpose, and so the specific example(s) mentioned below should not be understood as limiting.

FIG. 2 illustrates one arrangement for delivering messages according to a representative embodiment of the present invention. In this arrangement, central server 10 is provided with (e.g., stores or otherwise has access to) multiple different kinds of information, including: information 51 regarding the controlling entities 17, information 52 regarding the recipients 20, message-delivery information 54 and/or external information 55.

As indicated, in the present embodiment, any of the information 51-54 can be provided and/or modified, at least in part, by the forwarding servers 15. For this purpose, central server 10 preferably provides a user interface 60 that can be accessed by the forwarding servers 15. User interface 60 often is a web interface, e.g., with: file upload capabilities for uploading database and/or graphics files for the controlling-entity information 51 and/or recipient information 52, text boxes for entering and submitting proposed content 53, and/or checkboxes corresponding to different categories of potential recipients 20 and/or corresponding to different delivery times to be clicked for specifying delivery information 54. However, user interface 60 instead can include any other type of interface and/or any combination of different types of interfaces. For instance, one such user interface 60 can be implemented as a Twitter client (or a client for any other electronic messaging protocol) with a specific Twitter address for receiving tweets containing message content 53 that is proposed for delivery to all of the applicable forwarding servers 15 and then subsequent forwarding to the appropriate recipients 20. Similarly, different electronic addresses can be provided by central server 10 for receiving messages intended for different categories of individuals, e.g., one address for diabetic patients, a different one for patients with Parkinson's, etc. This algorithmic distribution mechanism can include any number of metadata parameters about the message content, the sender and the receiver so that the matches between those three elements can be extremely personalized, and then be distributed algorithmically using a sequence of media and timing that is determined to be most effective for a particular objective and a particular target population or individual.

In many cases, a controlling entity 17 will want to provide information 51 regarding itself and information 52 regarding its potential recipients 20 (e.g., those individuals who have agreed to receive messages from such controlling entity 17). Such information 51 and 52 (or updates to it) preferably can be uploaded by the corresponding server 15 upon manual designation, and/or server 15 can be configured to automatically synchronize its local copy of such information 51 and 52 to the information stored for it on central server 10. Alternatively, in some embodiments the central server 10 hosts the data 51 and 52 for the various controlling entities 17 and so no separate uploading of such information is required. The controlling-entity information 51 can include, e.g.: the name of the controlling entity 17 or its representative, where the controlling entity 17 is located, copies of one or more logos used by the controlling entity 17, contact information for the controlling entity 17 and/or areas of specialization (such as medical practice specialties) for the controlling entity 17. The recipient information 52 can include, e.g., for each potential recipient 20, that individual's or entity's: name, location, contact information and/or other characteristics (e.g., for the medical-office example, existing conditions and medical history (including multi-omics, psychographic signatures, personal preferences for communication, preferred language, health literacy, etc.). More generally, the characteristic information preferably is closely related to the specific purpose(s) for which messages are to be sent. In the present healthcare example, the majority (but not all) of such characteristic information will be medical and/or demographic information for each of the potential recipients 20. In any case, when provided, recipient information 52 often can be uploaded directly from controlling entity 17's database, either with conversion to any standardized format employed by central server 10 or without. The algorithms for probabilistically identifying which messages match which intended recipients, and how those messages are customized to the individual based upon their stored metadata can be applied in any of the stages of the message construction, distribution, and delivery process.

Substantive content information 53 can be formatted in any of a variety of different ways, e.g., ranging from a simple paragraph or block of text containing the message to be delivered, to a template message (e.g., with fields for insertion of personalized information), to a rule-based message definition (e.g., using a scripting language) that includes and/or excludes particular text based on specified characteristics of the intended recipient 20 and/or based on any other current information, to a multimedia production, or any combination of any or all of the foregoing. Content information 53 preferably can be generated by central server 10 and/or its administrators 12 and then modified by the controlling entities 17 and/or can be generated by controlling entities 17 in the first instance.

Delivery information 54 can include just the identification of one or more categories of recipients 20 who are to receive a particular message. In certain embodiments, delivery information 54 is formatted as a set of rules (e.g., using a scripting language or, more preferably, advanced decision support tools, services, and infrastructures). As shown in FIG. 3, in one representative embodiment each rule 70 specifies: a triggering condition 71 identifying the circumstances under which rule 70 is to be executed (i.e., when a particular messages to be delivered), an identification 72 of the substantive content 53 to be sent upon the occurrence of such triggering condition 71, one or more recipient criteria 73 identifying the characteristics of the recipients 20 who should receive such message content 72 (sometimes referred to as recipient applicability information), and/or one or more controlling-entity criteria 74 indicating how to select the controlling entities through which such message content 53 is to be sent (sometimes referred to as controlling-entity applicability information).

Generally speaking, the triggering condition 71, if included, will specify scheduling information, often simply the occurrence of a particular date or time, but potentially also (or instead) timing and sequencing of messaging across different media to the same individual(s). However, triggering condition 71 also (or instead) can include, e.g.: (1) the occurrence of any external event (e.g., a weather event, an air-quality condition, a financial, commercial and/or economic event, a natural disaster, or any other current event), as indicated by external information 55; (2) any action or event initiated by one or more controlling entities 17 and/or (3) any action or event initiated by one or more recipients 20. If triggering information 71 is omitted, central server 10 preferably executes the rule 70 at the first available opportunity. While not restricted to this use case, this algorithmically controlled delivery mechanism could be deployed powerfully during natural disasters or other events with unique signatures and impacted populations of individuals. The specific natural disaster would in this exemplary usage create a specific pattern of how the system would be deployed, across all five of the algorithmically managed parameters referenced throughout this disclosure.

Most of the delivery information 54 preferably is generated by the central server 10, at least in the first instance. The entire process could be constructed to be automatically triggered by a single event, e.g. a new open appointment for a surgical procedure, or it could be manually constructed in response to a specific novel event, e.g. availability of an entirely new service or procedure, or the occurrence of an unanticipated natural disaster or other untoward event e.g. terrorism. Both the automated rules that persist as well as the custom ad hoc rules that are constructed in response to a novel event (e.g. new service or procedure, or a natural disaster) preferably are authored in a rules authoring environment that leverages existing tools and services for managing large complex rule libraries, including pre-production testing and validation services and processes. However, as noted above, such delivery information 54 preferably also can be generated and/or modified by the forwarding servers (or subservices) 15 and/or their controlling entities 17. For instance, in certain embodiments a copy of the delivery information 54 that is applicable to a particular controlling entity 17 is provided to the controlling entity 17 (e.g., in the form of scripted rules) via its forwarding server 15. Upon reviewing such information (e.g., through an application running on its server 15, after such application has converted the formal scripting language into a more natural phrasing and presented the resulting text (and any multimedia elements) through a provided user interface), the controlling entity 17 can make any modifications to it that are desired in connection with the messages it wishes to deliver to its patients, clients or other recipients 20. This changed delivery information 54 is then uploaded back to central server 10 forwarding server 15 and is used for that specific controlling entity 17, e.g., with the particular changed rules replacing the standard rules within delivery information 54 for that particular entity 17. Similarly, each controlling entity 17 preferably have the ability to author and submit new rules 70 to be used for its recipients 20. In addition, in certain embodiments either the administrators 12 of central server 10 or other controlling entities 17 can review such rules changes and additions, and then decide whether to adopt them as the standard (in the case of the administrators 12 for central server 10) or to adopt them for themselves (in the case of other controlling entities 17). In this way, the entire community can collaborate in generating and refining the best practices for how and when messages are to be sent. As indicated above, similar or identical activities can occur with respect to each item of substantive content 53.

In short, through one or more user interfaces 60, each forwarding server 15 and/or its corresponding controlling entity 17 preferably has the ability to provide various kinds of information 51-54. In certain embodiments, the administrators 12 configure central server 10 (e.g., through a “permissions” user interface) to restrict who (e.g., which controlling entities 17) can submit substantive message content 53 and/or delivery information 54 for distribution.

The external information 55 can be provided, e.g., through the use of one or more clocks, dedicated sensors, third-party information feeds, web-crawling software, manual input, and/or any other desired source. The specific sources preferably depend upon the types of messages currently being handled by central server 10.

Returning to FIG. 2, in the preferred embodiments, all of the information 51-55 preferably is highly structured (e.g., using standardized, labeled fields), so as to be readily capable of machine interpretation. As discussed in greater detail below, based on such information 51-55: central server 10 generates and sends message units 56 to various forwarding servers 15; and upon receipt of its message unit(s) 56, and based on such message unit(s) 56, each such forwarding server 15 then generates and transmits a message to each of the appropriate recipients 20. According to the specific embodiment, message units 56 can include: all the information necessary to construct the messages sent to recipients 20 (e.g., so that no additional information is required by the forwarding servers 15). Alternatively, some or all of the message units 56 can include fields to be filled in by the forwarding servers 15 or otherwise are intended to be supplemented with information from forwarding servers 15.

In that regard, systems according to the present invention can be configured with varying amounts of information provided by the forwarding servers 15 to the central server 10. For example, based on privacy, trade secret and/or confidentiality concerns, controlling entities 17 often will not want to share at least some information with central server 10. On the other hand, particularly for controlling entities 17 that are not concerned about sharing information with central server 10, it often will be more convenient to essentially outsource as much of the functionality as possible. Thus, in the preferred embodiments, central server 10 accommodates different levels of information sharing by controlling entities 17.

In one example, illustrated in FIG. 4, at least one forwarding server 15 provides information 51 regarding its respective controlling entity 17 to central server 10, but does not share any of its recipient information 52. In this case, when it is time for a message to be sent by the central server 10, a single message unit 56 that includes the message content, the recipient criterion 73 and, potentially, other metadata (such as formatting information) for constructing the messages, might be sent to that forwarding server 15. Upon receipt of such a message unit 56, the forwarding server 15 executes process steps for identifying the appropriate recipients 20 to receive the message based on the recipient criterion 73 and then generates and sends messages to each of those recipients. More preferably, a message template is first generated and then a separate message is created and transmitted to each such recipient 20 by customizing the template (e.g., formatting it for the particular message-delivery system, adding in the address for the recipient 20, and/or including other information, such as the recipient 20's name and/or other personalized information). Again, this entire process can be fully automated or, e.g., a draft of the template message can be sent to the responsible individual with an controlling entity 17 for editing/approval before being distributed to the recipients 20. Although not specifically shown in FIG. 4, in this embodiment as well the controlling entity 17 preferably also can customize the default delivery information 54 for its own recipients 20, can review and adopt similar customizations made by other controlling entities 17 and/or can allow other controlling entities 17 to review and/or adopt its customizations. This intermediate level of information sharing can allow a controlling entity 17 to offload as much of the processing as possible to central server 10 while still maintaining control over information that it deems particularly sensitive. This customization at each node in the communication pathway preferably has both automated algorithmic options and manual options for both appending and amending of messages across an array of multimedia and communication platforms.

In a further embodiment, illustrated in FIG. 5, at least one forwarding server 15 does not share the controlling entity information 51 or the recipient information 52 with central server 10. However, even with this configuration the controlling entity 17 obtains the benefit of automatically receiving message units 56 that contain content to be forwarded to at least some of controlling entity 17's set of potential recipients 20. By configuring its forwarding server 15 to automatically generate messages that include such content and identify the appropriate recipients 20 from its database based on the applicability information contained within such message units 56, the entire process can still be fully automated (albeit with some additional upfront software development effort). Alternatively, if desired, manual editing/approval can be incorporated into the message-delivery protocol, e.g., as noted above. Although generally described herein as being a function of the forwarding servers 15, in certain embodiments of the invention, central server 10 instead (or also) forwards draft messages to the controlling entities 17 for their editing/approval before sending out the message information 56 to such controlling entities 17. Whether performed by central server 10 or the individual forwarding servers 15, in certain embodiments any editing feedback received from the controlling entities 17 is considered by the administrators 12 (for possible modifications to the general template) and/or other controlling entities 17 (for possible modifications to the specific version sent to their respective recipients 20).

In any of the various embodiments, the processing performed by any individual forwarding server 15 can be completely automatic or instead can be based on manual input from the controlling entity 17. Preferably, one or more options for manual input are provided in the configuration settings of the software executed by the forwarding server 15 so that the user has flexibility as to whether, when and/or how much manual approval, editing or other kinds of input are to be required. The determination of when a particular messaging campaign passes through a node automatically or whether it is subject to optional or mandatory review and optional or mandatory manual editing, preferably can be made both at the level of the initiation of the campaign and the associated message content and rules, as well as at the level of the nodes. A ‘handshake’ can occur as each message crosses each node to determine whether both general and local rules permit automated passage, optional manual review, or mandatory manual review. The state transition model for managing these three states preferably manages the triggering of either the accountable person or entity of the available optionality of manual modifications, e.g. with message escalation and time bombs for response, or require the manual review and sign-off before further communication to downstream nodes when the manual review is mandatory.

FIG. 6 is a flow diagram illustrating a process 100 for delivering messages in accordance with the present invention. As indicated below, execution of the process steps illustrated in FIG. 6 can be divided between the central server 10 and the individual forwarding servers 15 in a variety of different ways in order to achieve different results. As further indicated below, although the process steps of FIG. 6 are shown and described in a particular order, the order can be varied significantly in different embodiments of the invention.

Initially, in step 102 a trigger condition is detected. In the preferred embodiments, central server 10 continuously scans its stored delivery information 54, examining each rule 70 and, more specifically, the triggering condition 71 of each such rule 70, to determine whether such triggering condition 71 has been satisfied. When one has been satisfied, the trigger condition is declared and the corresponding rule 70 is identified.

In step 103, the recipients who are to receive the message content 72 are identified. When performed at this point in the overall process 100, step 103 typically will be performed by the central server 10 with respect to all of the potential recipients 20 in the system 5. However, it instead could be performed by the individual forwarding servers 15 with respect to just those recipients 20 were affiliated with each subject forwarding server 15 and/or its controlling entity 17. In either event, the recipient criteria 73 preferably are compared against the stored recipient information 52 in order to determine which recipients 20 should receive the subject message. For this purpose, the recipient information 52 preferably is highly structured and the recipient criteria 73 are specified as one or more conditions on specific designated values that are stored for the recipients 20. For instance, a recipient criterion 73 could be formulated as any individual: (1) having a medical condition code of type II diabetes; (2) that is at least X years old (or, equivalently, that was born before a specified date); and (3) that has at least one of three other specified medical conditions and/or other characteristics. The recipient criteria 73 and the corresponding message content 72 preferably are closely matched, so the individual recipients 20 receive messages that are tailored to them (e.g., to their medical conditions or, for alternate uses, to their business or consumption needs or to any other characteristics, circumstances or needs they may have). The identification of recipients 20 to receive the current message content 72 preferably is performed using known database query techniques, and algorithmic matching of the metadata about both the message and the individual as noted above. All five parameters in the pentad noted above preferably serve as substrates to apply the algorithms to in order to construct the details of each messaging campaign for each intended recipient.

In step 105, the forwarding servers 15 through which the current message content 72 is to be delivered are identified. This step can be performed either before or after step 103. Also, when performed at this point of process 100, it typically will be performed by central server 10. However, it instead could be performed by the individual forwarding servers 15, e.g., where each server 15 after receiving a message unit 56 determines whether it is an appropriate entity to forward the subject message content 72. In either event, this step 105 preferably is performed in a similar manner to step 104. That is, the controlling-entity criteria 74 are compared against the controlling-entity information 51 to determine whether there is a match. If so, the subject controlling entity 17 is at least a candidate for forwarding the current message content 72. If not, the subject controlling entity 17 is not deemed a candidate. Examples of a controlling-entity criterion 74 include: “all physicians”, “all pediatricians”, “all cardiologists”, or “all physicians practicing in San Diego”. Again, these are merely illustrative categories, but the metadata aspects of each nodal entity or individual are in no way constrained by the system. These entities can be individuals, roles, services, avatars, or other intelligent agents.

One advantage of having this step 105 performed by the central server 10 is that it is then easier to identify situations where multiple controlling entities 17 are appropriate for forwarding the current message content 72 (e.g., where the controlling-entity criterion 74 is “all physicians” and a particular patient 20 has more than one physician 17 who uses the system 5). In that case, it often will be desirable to avoid having the same entity 17 forward identical message content 72 to the same recipient 20. Therefore, in such a case, central server 10 preferably assigns and appropriateness score (based on the controlling-entity criteria 74) to each such candidate entity 17 and selects only the entity 17 that has the highest score (or, e.g., makes an arbitrary selection in the event of a tie). In this way, the controlling-entity criterion 74, e.g., can be useful to determine who would be appropriate for forwarding particular message content 72. For instance, even though a particular recipient 20 might be appropriate for receiving a message concerning a heart medication that individual is indicated as taking, it might not be appropriate to forward such a message through his or her urologist. The preferred objective is to provide a deliberate staging and sequence of messaging that is predicted to or has been observed to achieve maximum desired response from each target individual, while preserving the personalization aspects of having a ‘sender’ that is more proximal to the individual in their network of trust.

Where such situations are to be accommodated, the controlling-entity criteria 74 generates one of multiple possible values (e.g., at least 3-5 such possible values), rather than just a binary output. In some contexts, such as commercial contexts, it is desirable to base such controlling-entity scores 74 on factors other than intrinsic characteristics of the competing entities 17, such as which entity is paying a higher rate (and thus is more profitable to the administrators 12 of the central server 10). A similar approach can be employed where this step 105 is performed by the individual forwarding servers 15, e.g., by having them determine their own scores, forward them to the central server 10 (if they are potential candidates), and then have the central server 10 identify who has the highest score, but this alternate approach tends to be more cumbersome.

In step 106, central server 10 constructs the message information 56 to be sent to the forwarding servers 15 identified in step 105. Such information 56 preferably is in the form of discrete message units. One or more of such message units 56 can be sent to any particular forwarding server 15 in connection with a single messaging event. In addition, the form of the message units 56 can vary depending upon the embodiment and/or depending upon elections made by the various controlling entities 17. For example, in some cases, each message unit 56 sent to a particular forwarding server 15 correspondence on a one-to-one basis with the individual messages that will be forwarded by such forwarding server 15, with such message unit containing all of the information to construct the corresponding message for a single recipient 20. In other cases, just a single message unit 56 is sent to a particular forwarding server 15 and contains all of the information necessary for forwarding server 15 to generate all of the messages it will be sending to its recipients 20 in connection with the current messaging event, such as: a template message that includes the substantive content and a list of the recipients 20 who are to receive the message from the subject forwarding server 15 (or the recipient criteria 52 for identifying those recipients 20). Preferably, the message information 56 is constructed using a proprietary format, specific to the present purpose, so that it can be readily decoded by the forwarding servers 15 that receive it.

In step 108, the central server 10 forwards the message information 56 to the respective forwarding servers 15. As noted above, all of the communications between central server 10 and forwarding servers 15 preferably occurs over the Internet. However, any other wide-area network instead can be used.

In step 109, upon receiving the message information 56 from the central server 10, each individual forwarding server 15 generates and transmits messages to the appropriate recipients 20. In the preferred embodiments, a separate message is generated for each such recipient 20, and each message only indicates the corresponding controlling entity 17 (and/or some individual associated with entity 17) as the sender. That is, rather than simply forwarding messages from central server 10, which typically would show the transmission chain (including that the message originated with central server 10), an entirely new message preferably is generated for each recipient 20 (albeit based on the received message information 56). On the other hand, in some embodiments the original message is 56 are simply forward it on to the recipients 20; however, in these embodiments any indication that the message was originated by central server 10 preferably is removed or omitted prior to such forwarding, again so that it appears to the ultimate recipients 20 that the messages originated with the controlling entity 17 (and/or some individual associated with entity 17). The use of commercial products like Twitter, Facebook, etc. preferably are used as appropriate and their internal server topology preferably is treated by products based on this invention as a ‘black box’, but proprietary social network services could also be built and deployed with a resulting disintermediation of the commercial communication and social products as appropriate.

The construction of the messages in this step 109 preferably is dependent upon the particular embodiment and/or the configuration settings chosen by the controlling entity 17, mostly pertaining to how much information controlling entity 17 has shared with central server 10. Thus, as noted above, this step 109 can involve little more than repackaging individual message units into corresponding messages to be delivered to the recipients 20. On the other hand, it can involve any or all of: identifying the appropriate recipients 20 based on the recipient criteria 73, populating information pertaining to controlling entity 17 into appropriate fields within a message template received as part of information 56, generating a copy of such a template for each intended recipient 20 and then populating information pertaining to such recipient 20 (e.g., electronic address and, potentially, other personal and/or recipient-specific information) into appropriate fields, and/or merging the message content received as part of information 56 into a standard message format used by controlling entity 17. Also, as noted above, any given forwarding server 15 also may be configured to: forward a message template (e.g., including everything but the recipient-specific information) to an individual associated with controlling entity 17 for editing and/or approval, receive such feedback, and then incorporate any indicated changes, as part of the message-construction portion of this step 109.

In many cases, construction of the messages also will depend upon the particular delivery channel(s) that are intended to be used for each recipient 20. For example, the format of a Twitter message typically will be different than the format of an e-mail message, which will be different than the format of a Facebook message, which will be different than the format of a text message, etc. The capacity for multi-media messaging might be constrained by the communication media but not necessarily by the products or messaging campaigns that are built on top of this invention. Part of the stored information for each recipient 20 preferably is an indication as to which communication channel(s) the recipient 20 has chosen to be used for this purpose. In any event, the central server 10 preferably can be configured to add any desired additional information to the messages 28 it sends out to the recipients 20, e.g., any generic text, logos or other aesthetic elements and/or any information specific to the controlling entity 17 or the individual recipient 20, either on a prompted basis (such as by filling in a field included by central server 10) or on an unprompted basis (such as in accordance with a standard template used by controlling entity 17).

In the preceding embodiments, a central server 10 generates message content 56 and transmits it to multiple different forwarding servers 15 which, in turn, generate individual messages based on such content and transmit such messages to recipients 20 who are associated with an entity 17 that controls the individual forwarding servers 15. This multilevel message distribution approach often can provide greater efficiency by consolidating most of the effort that is involved in sending out messages to a large number of people, while simultaneously ensuring that the ultimate recipients receive the messages from a person or entity with whom they have a fairly close and/or trusted relationship.

FIG. 7 illustrates how this distribution approach can be extended by allowing one or more additional levels of forwarding servers. As in the previous embodiments, a central server 10 generates and transmits message information 56 to a number of forwarding servers 15A-C. Some of such forwarding servers (e.g., servers 15A&C) then generate messages based on such information 56 and transmit them to the devices 25 for the ultimate recipients 20. In addition, some of the forwarding servers (e.g., servers 15A&B) also (or instead) forward the message information 56 (in some cases, after supplementing and/or modifying it) to lower-level forwarding servers 115 which, in turn, then generate messages and transmit them to the devices 25 of the ultimate recipients 20. For example, forwarding servers 15A&B might be operated by controlling entities 17 that are doctors' offices, while forwarding servers 115 might be operated by physical therapists or other professionals who work with those doctors. In this arrangement, e.g., forwarding servers 15A&B may employ any of the functionality described above for forwarding servers 15 as well as any of the functionality described above for central server 10, and forwarding servers 115 may employ any of the functionality described above for forwarding servers 15. More specifically, at each stage (e.g., central server 10, forwarding servers 15A&B and downstream forwarding servers 115), any additional content and/or aesthetic formatting may be added to customize the ultimate messages that are to be delivered.

In the embodiments discussed above, all or most of the message-delivery processing occurs on an automated basis. Such message delivery-systems are believed to be the most efficient. However, in certain embodiments, some or all of the message-forwarding steps are performed on an manual basis (e.g., with the controlling entity 17 manually re-tweeting and incoming message to a pre-defined distribution list). Whenever any manual steps are to be performed, it often will be preferable to monitor the activity at each such step in the process to determine how effectively the corresponding messages are being distributed. Similarly, it often will be desirable to monitor subsequent actions taken by recipients 20 of the messages 28 in order to determine how effective the messages 28 are at inducing behavioral changes.

### Representative Instantiation

This section presents one representative instantiation of the present invention.

Level 1 requirement #1: Find a patient whose resource needs maximally exploit the available slot.

Level 2 requirements:

a) Identify all resources that had been dedicated to the “event” (surgery, imaging, genetic counseling, etc. etc.) for the cancelled procedure that might “perish” financially if they are not re-utilized in the replacement case.
b) Rank order the “scarcity” and “perishability” of those resources so that we find a replacement patient which most extensively utilizes those scarce and perishable resources.
c) Identify all the resources associated with the procedure/event of the people who are in the queues, using the identical taxonomy of resources used for the cases that have been cancelled.
d) Apply the prioritized criteria against the candidates in the list to rank order the candidates in terms of their suitability for maximal utilization of both scare and perishable aspects of the previously scheduled appointment.
e) Notify all appropriate candidates through social eLert communication mechanisms.
f) Notify each respondent that their message has been received and that they should be “on call” for that time/date until they receive further notification.
g) As soon as any “HIGH MATCH” patient responds, notify them that they have that date/time secured, and notify all other matches that they will be on the wait list for that appt until it is too late to prep them (in the event that the HIGH MATCH defaults for any reason).
h) Immediately initiate the full preparation of the new HIGH MATCH candidate for the procedure.
i) In the event that there are no “HIGH MATCH” candidates within the necessary window, select the best match (or matches, e.g. two 2-hour events to fill a single 4 hr slot if we can't find a 4 hr need among any of the candidates. Identify all resources required by this patient that were not dedicated in the event that was cancelled and quickly identify the ability to secure those resources.
j) Notify the “best match” candidate and proceed with full registration/scheduling for the procedure.
k) Notify the others in the queue that they are waitlisted for that slot pending further notice.
l) Notify all that they are not candidates for that slot when the critical window has passed without default of the primary new candidate.

Level 1 requirement #2: Find a patient with the most urgent need for expedited scheduling.

Level 2 requirements:

a) rank order each patient in the queue by relative urgency from a clinical perspective (risk, pain, disability, etc.)
b) Use the urgency as one input to the “BEST MATCH” determination.

Level 1 requirement #3: Expand geographic scope for listing candidates:

Level 2 requirements:

a) Proactive expansion candidacy: When the candidate list is for a relatively common resource, then a local candidate queue list is appropriate. When the resource is a tertiary referral type resource, then expansion to all of SCAL region, or potentially to all of KP would be appropriate (could extend to non-KP members on a FFS basis as well).
b) Reactive expansion of candidacy: If there is a very small number of local candidates for a resource, then establish a mechanism to expand the candidacy list across medical centers, i.e. Add concentric circles of geography based on a predefined “minimum set” of potential candidates. Example: If ideally you like to have 10 candidates registered for a cancellation event but you only have 2 on the list, expand to OC and Riv medical centers. If you only get to 8, then expand to Downey and Fontana, etc.

### System Environment.

Generally speaking, except where clearly indicated otherwise, all of the systems, methods, functionality and techniques described herein can be practiced with the use of one or more programmable general-purpose computing devices. Such devices (e.g., including any of the electronic devices mentioned herein) typically will include, for example, at least some of the following components interconnected with each other, e.g., via a common bus: one or more central processing units (CPUs); read-only memory (ROM); random access memory (RAM); input/output software and circuitry for interfacing with other devices (e.g., using a hardwired connection, such as a serial port, a parallel port, a USB connection or a FireWire connection, or using a wireless protocol, such as radio-frequency identification (RFID), any other near-field communication (NFC) protocol, Bluetooth or a 802.11 protocol); software and circuitry for connecting to one or more networks, e.g., using a hardwired connection such as an Ethernet card or a wireless protocol, such as code division multiple access (CDMA), global system for mobile communications (GSM), Bluetooth, a 802.11x protocol, or any other cellular-based or non-cellular-based system, which networks, in turn, in many embodiments of the invention, connect to the Internet or to any other networks; a display (such as a cathode ray tube display, a liquid crystal display, an organic light-emitting display, a polymeric light-emitting display or any other thin-film display); other output devices (such as one or more speakers, a headphone set and/or a printer); one or more input devices (such as a mouse, touchpad, tablet, touch-sensitive display or other pointing device, a keyboard, a keypad, a microphone and/or a scanner); a mass storage unit (such as a hard disk drive or a solid-state drive); a real-time clock; a removable storage read/write device (such as a flash drive, any other portable drive that utilizes semiconductor memory, a magnetic disk, a magnetic tape, an opto-magnetic disk, an optical disk, or the like); and a modem (e.g., for sending faxes or for connecting to the Internet or to any other computer network). In operation, the process steps to implement the above methods and functionality, to the extent performed by such a general-purpose computer, typically initially are stored in mass storage (e.g., a hard disk or solid-state drive), are downloaded into RAM, and then are executed by the CPU out of RAM. However, in some cases the process steps initially are stored in RAM or ROM and/or are directly executed out of mass storage.

Suitable general-purpose programmable devices for use in implementing the present invention may be obtained from various vendors. In the various embodiments, different types of devices are used depending upon the size and complexity of the tasks. Such devices can include, e.g., mainframe computers, multiprocessor computers, one or more server boxes, workstations, personal (e.g., desktop, laptop, tablet or slate) computers and/or even smaller computers, such as personal digital assistants (PDAs), wireless telephones (e.g., smartphones, smart tablets, smart glasses with augmented reality, etc.) or any other programmable appliance or device, whether stand-alone, hard-wired into a network or wirelessly connected to a network.

In addition, although general-purpose programmable devices have been described above, in alternate embodiments one or more special-purpose processors or computers instead (or in addition) are used. In general, it should be noted that, except as expressly noted otherwise, any of the functionality described above can be implemented by a general-purpose processor executing software and/or firmware, by dedicated (e.g., logic-based) hardware, or any combination of these approaches, with the particular implementation being selected based on known engineering tradeoffs. More specifically, where any process and/or functionality described above is implemented in a fixed, predetermined and/or logical manner, it can be accomplished by a processor executing programming (e.g., software or firmware), an appropriate arrangement of logic components (hardware), or any combination of the two, as will be readily appreciated by those skilled in the art. In other words, it is well-understood how to convert logical and/or arithmetic operations into instructions for performing such operations within a processor and/or into logic gate configurations for performing such operations; in fact, compilers typically are available for both kinds of conversions.

It should be understood that the present invention also relates to machine-readable tangible (or non-transitory) media on which are stored software or firmware program instructions (i.e., computer-executable process instructions) for performing the methods and functionality of this invention. Such media include, by way of example, magnetic disks, magnetic tape, optically readable media such as CDs and DVDs, or semiconductor memory such as various types of memory cards, USB flash memory devices, solid-state drives, etc. In each case, the medium may take the form of a portable item such as a miniature disk drive or a small disk, diskette, cassette, cartridge, card, stick etc., or it may take the form of a relatively larger or less-mobile item such as a hard disk drive, ROM or RAM provided in a computer or other device. As used herein, unless clearly noted otherwise, references to computer-executable process steps stored on a computer-readable or machine-readable medium are intended to encompass situations in which such process steps are stored on a single medium, as well as situations in which such process steps are stored across multiple media.

The foregoing description primarily emphasizes electronic computers and devices. However, it should be understood that any other computing or other type of device instead may be used, such as a device utilizing any combination of electronic, optical, biological and chemical processing that is capable of performing basic logical and/or arithmetic operations.

In addition, where the present disclosure refers to a processor, computer, server, server device, computer-readable medium or other storage device, client device, or any other kind of device, such references should be understood as encompassing the use of plural such processors, computers, servers, server devices, computer-readable media or other storage devices, client devices, or any other devices, except to the extent clearly indicated otherwise. For instance, a server generally can (and often will) be implemented using a single device or a cluster of server devices (either local or geographically dispersed), e.g., with appropriate load balancing.

### Additional Considerations.

In certain instances, the foregoing description refers to clicking or double-clicking on user-interface buttons, dragging user-interface items, or otherwise entering commands or information via a particular user-interface mechanism and/or in a particular manner. All of such references are intended to be exemplary only, it being understood that the present invention encompasses entry of the corresponding commands or information by a user in any other manner using the same or any other user-interface mechanism. In addition, or instead, such commands or information may be input by an automated (e.g., computer-executed) process.

References herein to a “criterion”, “multiple criteria”, “condition”, “conditions” or similar words which are intended to trigger, limit, filter or otherwise affect processing steps, other actions, the subjects of processing steps or actions, or any other activity or data, are intended to mean “one or more”, irrespective of whether the singular or the plural form has been used. For instance, any criterion or condition can include any combination (e.g., Boolean combination) of actions, events and/or occurrences (i.e., a multi-part criterion or condition).

Several different embodiments of the present invention are described above, with each such embodiment described as including certain features. However, it is intended that the features described in connection with the discussion of any single embodiment are not limited to that embodiment but may be included and/or arranged in various combinations in any of the other embodiments as well, as will be understood by those skilled in the art.

Similarly, in the discussion above, functionality sometimes is ascribed to a particular module or component. However, functionality generally may be redistributed as desired among any different modules or components, in some cases completely obviating the need for a particular component or module and/or requiring the addition of new components or modules. The precise distribution of functionality preferably is made according to known engineering tradeoffs, with reference to the specific embodiment of the invention, as will be understood by those skilled in the art. Similarly the network and server topology for allocation of services across both logical and physical components is not constrained by this invention and the invention can be implemented across many different topologies.

Thus, although the present invention has been described in detail with regard to the exemplary embodiments thereof and accompanying drawings, it should be apparent to those skilled in the art that various adaptations and modifications of the present invention may be accomplished without departing from the spirit and the scope of the invention. Accordingly, the invention is not limited to the precise embodiments shown in the drawings and described above. Rather, it is intended that all such variations not departing from the spirit of the invention be considered as within the scope thereof as limited solely by the claims appended hereto.

What is claimed is:

1. A system for distributing electronic messages, comprising:
(a) a central server that: (i) is connected to a wide-area network and (ii) stores substantive message content information and corresponding delivery information; and
(b) a first plurality of forwarding servers, each: (i) being connected to the wide-area network and (ii) having an associated set of recipients,
wherein the central server is configured, based on the delivery information, to automatically transmit message information, which includes substantive message content information, across the wide-area network to a second plurality of the forwarding servers, the second plurality of the forwarding servers being at least a subset of the first plurality of the forwarding servers, and the substantive message content information being identical for all of the second plurality of forwarding servers, and
wherein each of the second plurality of forwarding servers is configured, upon receipt of the message information, to automatically generate and then transmit to each of a plurality of the recipients within its associated set a message that includes the substantive message content information.

2. A system according to claim 1, wherein the message information also includes applicability information, and wherein at least some of the second plurality of the forwarding servers also are configured, upon receipt of the message information, to automatically identify the plurality of the recipients within its associated set based on the applicability information.

3. A system according to claim 2, wherein the applicability information comprises a set of structured criteria, and wherein each said at least some of the second plurality of the forwarding servers identifies each of the plurality of the recipients to whom a message is to be sent by screening its associated set in accordance with said structured criteria.

4. A system according to claim 1, wherein at least some of the second plurality of the forwarding servers also are configured to automatically customize the message transmitted to each of the plurality of the recipients within their associated sets.

5. A system according to claim 4, wherein said automatic customizing comprises addition of information that is specific to at least one of an entity or an individual that controls the respective participating forwarding server.

6. A system according to claim 4, wherein said automatic customizing comprises addition of an electronic address for the respective recipient.

7. A system according to claim 4, wherein said automatic customizing comprises addition of recipient-specific information other than an electronic address.

8. A system according to claim 1, wherein the central server is configured to permit individual forwarding servers to customize the delivery information for messages ultimately to be transmitted to recipients within said individual forwarding servers' associated sets.

9. A system according to claim 8, wherein the central server also is configured to make the customized delivery information available to other ones of the forwarding servers for them to adopt, if desired, for messages ultimately to be transmitted to recipients within their associated sets.

10. A system according to claim 1, wherein the central server is configured to permit individual forwarding servers to customize recipient-applicability information for messages ultimately to be transmitted to recipients within their associated sets.

11. A system according to claim 1, wherein the message information transmitted to at least some of the second plurality of the forwarding servers includes all information required to generate the messages to be transmitted to the plurality of the recipients within the associated sets of the respective forwarding servers.

12. A system according to claim 1, wherein the second plurality of forwarding servers are configured to transmit the messages via at least one of e-mail, text messaging and messaging over a social-network service.

13. A system according to claim 1, wherein at least one of the forwarding servers is configured, upon receipt of the message information, to automatically generate and then to transmit a template sample message for editing and approval by a selected individual associated with the selected one of the participant forwarding servers prior to the at least one of the forwarding servers transmitting the messages to the recipients within its associated set.

14. A system according to claim 1, wherein the wide-area network comprises the Internet.

15. A system according to claim 1, wherein the messages sent by a participating forwarding server only indicate a source of said messages as being at least one of an entity that controls said participating forwarding server or an individual associated with said entity.

16. A system according to claim 1, wherein the central server also stores information regarding an entity that controls each of a plurality of the forwarding servers, and wherein the message information that the central server transmits to a particular participating forwarding server is based on the stored information regarding the entity that controls said participating forwarding server.

17. A system according to claim 1, wherein the central server also stores information regarding the sets of recipients associated with each of a plurality of the forwarding servers, and wherein the message information the central server transmits to a particular participating forwarding server is based on the stored information regarding the set of recipients associated with said participating forwarding server.

18. A system according to claim 1, wherein the central server also stores information regarding the sets of recipients associated with each of a plurality of the forwarding servers, and wherein the central server identifies the recipients to whom the messages ultimately are to be sent based on the stored information regarding the set of recipients associated with said participating forwarding server.

19. A system according to claim 1, wherein the delivery information include scheduling information for future delivery of the substantive message content information.

20. A system according to claim 1, wherein the central server presents a user interface that allows individual forwarding servers and responsible agents and individuals to submit substantive message content information for delivery across the first plurality of forwarding servers.

21. A system according to claim 1, wherein message modifications may be made downstream from an original message creation by an individual that is responsible for a downstream node between a message originator and at least one intended recipient.

22. A system according to claim 21, wherein each node in a chain between the message originator and said at least one intended recipient is a locus for at least one of three review processes that include:
a) automated pass through,
b) automated notification of an optional review period for manual modification, and
c) automated notification of mandatory review.

23. A system according to claim 1, wherein said system comprises a capability to mass-customize a messaging campaign across five parameters in a key pentad that includes: message, sender, receiver, plural media, and timing/sequencing/repetition of media and messages to a target population or individual, based upon metadata around each of said five parameters, and a set of algorithmic rules that operate on the metadata across all five parameters.
